(19) United States
(12) Patent Application Publication
(10) Pub. No.: US 2026/0264744 A1
(43) Pub. Date: Sep. 10, 2026

(54) ANTI-ROTATION SLEEVE FOR STEERING ACTUATOR

(71) Applicant: Schaeffler Technologies AG & Co. KG, Herzogenaurach (DE)

(72) Inventors: Trenton Dean, Harrison Twp, MI (US); Sang Hoon Han, Shelby Township, MI (US); Alaa Makke, Rochester, MI (US)

(73) Assignee: Schaeffler Technologies AG & Co. KG, Herzogenaurach (DE)

(21) Appl. No.: 19/561,680

(22) Filed: Mar. 10, 2026

Related U.S. Application Data
(60) Provisional application No. 63/769,399, filed on Mar. 10, 2025.

(51) Int. Cl. B62D 5/04

(52) U.S. Cl. CPC B62D 5/0445; B62D 5/0424

(57) ABSTRACT

A vehicle steering system is provided that includes an actuator driving a threaded nut, a threaded spindle configured to move linearly within a housing via rotation of the threaded nut, and an anti-rotation sleeve fixed to the housing. The anti-rotation sleeve has a plurality of balls that rollably engage a plurality of grooves on the threaded spindle, and a plurality of spherical ball pockets that rollably receive the plurality of balls. One or more of the plurality of spherical ball pockets is formed by a pair of spherical ball pocket portions.

### CROSS REFERENCE TO RELATED APPLICATIONS

This application claims priority to U.S. Provisional Application 63/769,399 filed March 10, 2025, the entire disclosure of which is incorporated by reference herein.

### TECHNICAL FIELD

The disclosure relates to a vehicle steering actuator for a steer by wire vehicle, and, more particularly, to an anti-rotation sleeve incorporated therein.

### BACKGROUND

Steer by wire systems can eliminate physical connection between a steering wheel and the wheels of a car. Steer by wire systems often employ linear actuators that utilize electric motors and screw drives.

### SUMMARY

An example embodiment of a vehicle steering system includes an actuator that drives a threaded nut, a threaded spindle disposed in a housing and configured to move linearly along an axis via rotation of the threaded nut, and a sleeve fixed to the housing. The sleeve is configured to prevent rotation of the threaded spindle about the axis. The sleeve includes a through-bore through which the threaded spindle extends, a first plurality of balls configured to rollably engage a plurality of axial grooves disposed on the threaded spindle, and a first plurality of spherical ball pockets. Each of the spherical ball pockets: i) rollably receives the first plurality of balls, and ii) is formed by a first pair of spherical ball pocket portions. Each one of the first plurality of spherical ball pockets may be isolated from each other.

In an example embodiment, the spherical ball pocket portions are formed by angled landings.

In an example embodiment, the first pair of spherical pocket portions includes: i) a first spherical portion formed within a first angled landing, and ii) a second spherical portion formed within a second angled landing that abuts with the first angled landing.

In an example embodiment, the sleeve is assembled from a plurality of separate sleeve segments. A first sleeve segment includes a first one of a pair of spherical ball pocket portions, and a second sleeve segment includes a second one of a pair of spherical ball pocket portions. In a further aspect, the first and second sleeve segments are constructed from a polymer.

In an example embodiment, the vehicle steering system also includes: i) a second plurality of balls that rollably engage the plurality of axial grooves, ii) a second plurality of spherical ball pockets, iii) a third sleeve segment, and iv) a fourth sleeve segment. Each one of the second plurality of spherical ball pockets rollably receives one of the second plurality of balls, and one or more of the second plurality of spherical ball pockets is formed by a second pair of ball pocket portions. The third sleeve segment includes a first one of the second pair of spherical ball pocket portions. The fourth sleeve segment includes a second one of the second pair of spherical ball pocket portions. In an example embodiment, each one of the second plurality of balls is separated from each other.

In an example embodiment, one of the first plurality of balls is axially aligned with one of the second plurality of balls such that both balls rollably engage a same one of the plurality of axial grooves on the threaded spindle.

In an example embodiment, the sleeve includes a plurality of snap-fit sleeve segments that form the first plurality of ball pockets. In a further aspect, the plurality of snap-fit sleeve segments form a circumferentially alternating tab and slot coupling which comprises the first plurality of ball pockets.

In an example embodiment, the first plurality of ball pockets are formed via angled landings or angled sides of the plurality of snap-fit sleeve segments.

In an example embodiment, a first angled landing of one of the sleeve segments engages a second angled landing of another one of the sleeve segments to define an angled split line of one of the first plurality of ball pockets.

In an example embodiment, the sleeve is an assembly of separate sleeve segments, including a first separate sleeve segment that includes first axial protrusions, and a second separate sleeve segment that includes second axial protrusions that complementarily engage the first axial protrusions so as to form the ball pockets. One or more of the first axial protrusions includes a first portion of one of the ball pockets, and one or more of the second axial protrusions includes a second portion of one of the ball pockets. In a further aspect, the first and second portions may be shaped as spherical segments.

In an example embodiment, one of the first axial protrusions is lockingly disposed circumferentially between a first one and a directly adjacent second one of the second axial protrusions.

### BRIEF DESCRIPTION OF THE DRAWINGS

FIG. 1 is a perspective view of an example embodiment of a steering system actuator for a steer by wire vehicle together with a threaded spindle and an anti-rotation sleeve.

FIG. 2 is a perspective view of the threaded spindle and the anti-rotation sleeve of FIG. 1.

FIG. 3 is a perspective view of the threaded spindle and the anti-rotation sleeve of FIG. 1.

FIG. 4 is a cross-sectional view taken from FIG. 3.

FIG. 5 is an exploded perspective view of the anti-rotation sleeve of FIG. 3.

FIG. 6 is a perspective view of an end segment of the anti-rotation sleeve of FIG. 3.

FIG. 7 is a perspective view of a modular segment of the anti-rotation sleeve of FIG. 3.

FIGS. 8A, 8B, and 8C, are perspective views of an assembly process of a portion of the anti-rotation sleeve of FIG. 3.

FIG. 9 is a cross-sectional view taken from FIG. 3.

FIG. 10 is a partial cross-sectional view taken from FIG. 1.

FIGS. 11A, 11B, 11C, and 11D, are perspective views of four different example embodiments of radial pre-load devices for the anti-rotation sleeve of FIG. 3.

FIGS. 12A and 12B are cross-sectional views taken from FIG. 1.

FIG. 13 is a perspective view of the end segment of FIG. 6 together with a bushing.

FIG. 14A is a front view of an assembly snap-fit of the modular segment of FIG. 7 to the end segment of FIG. 6.

FIG. 14B is a detailed view taken from FIG. 14A.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

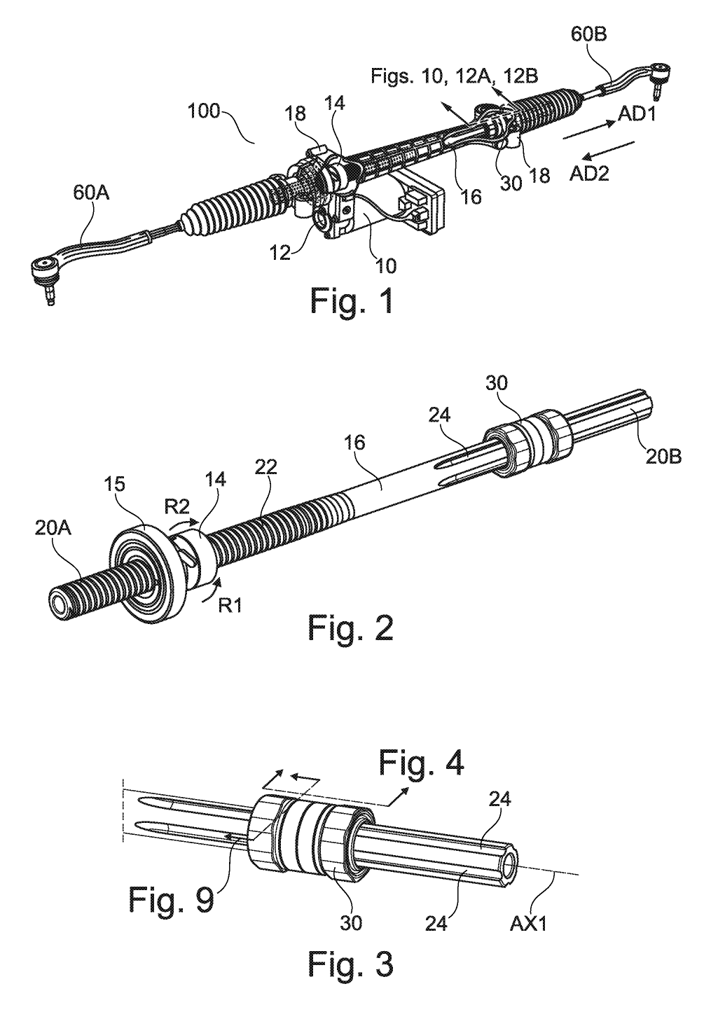

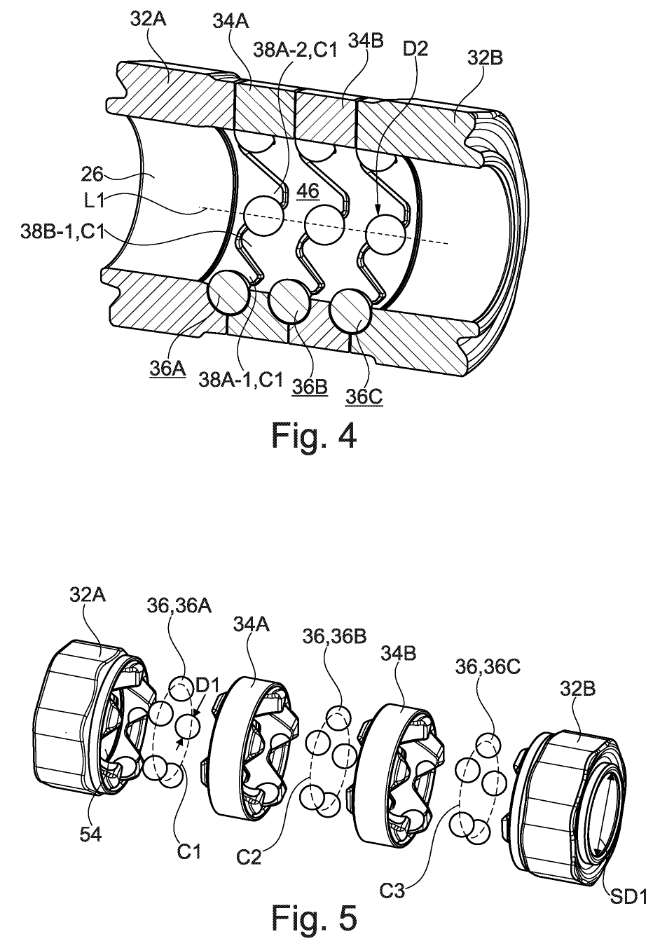

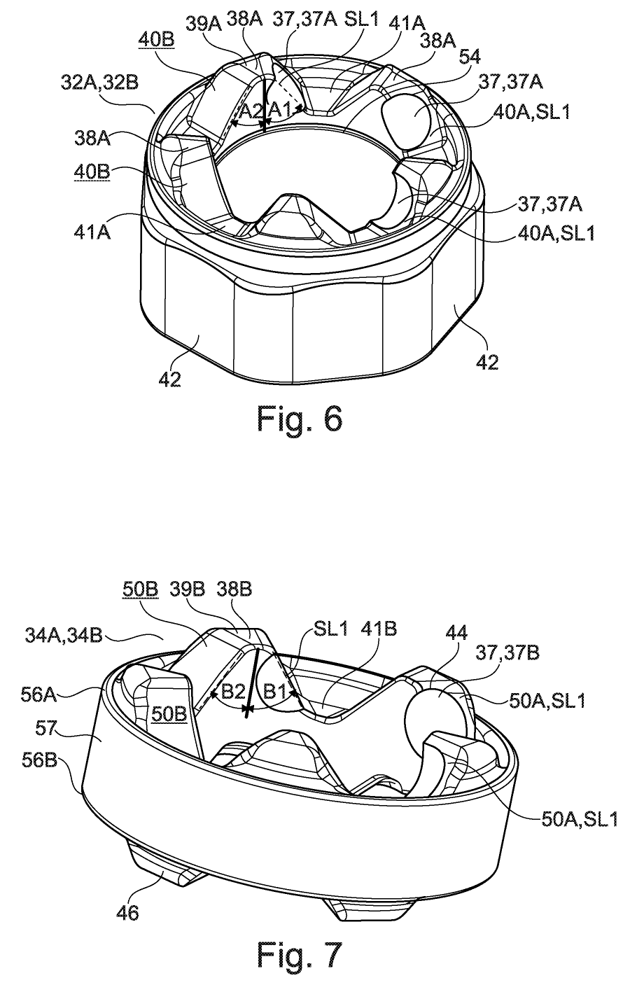

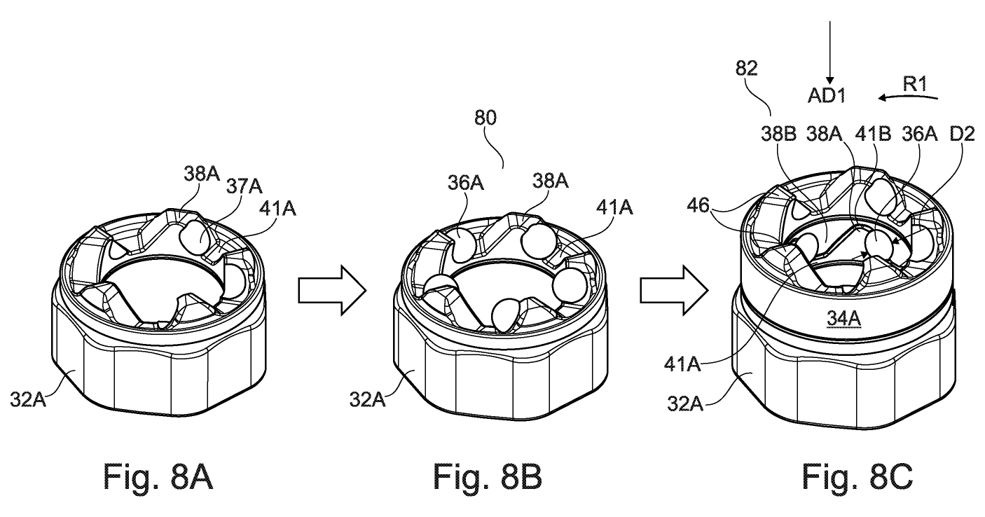

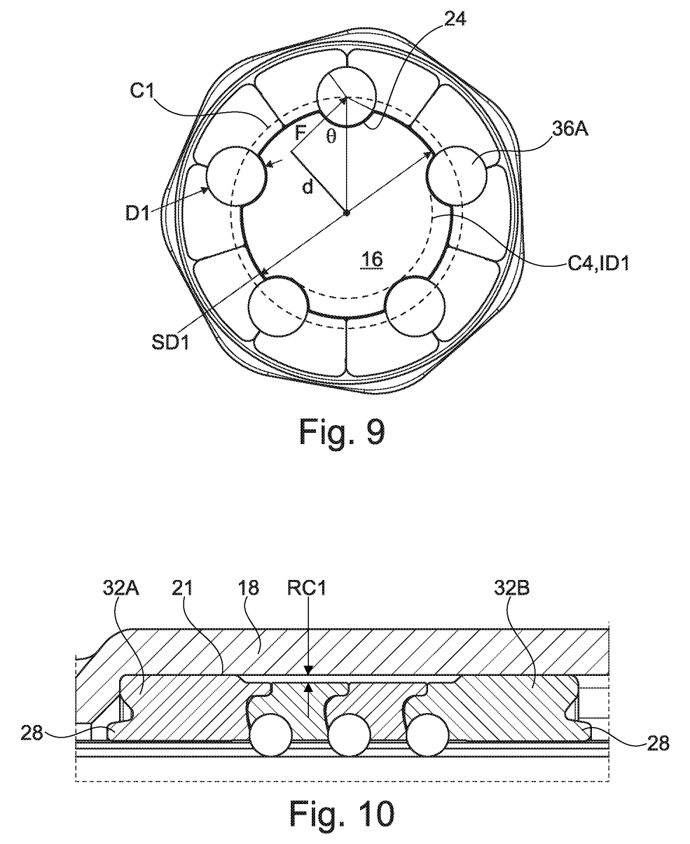

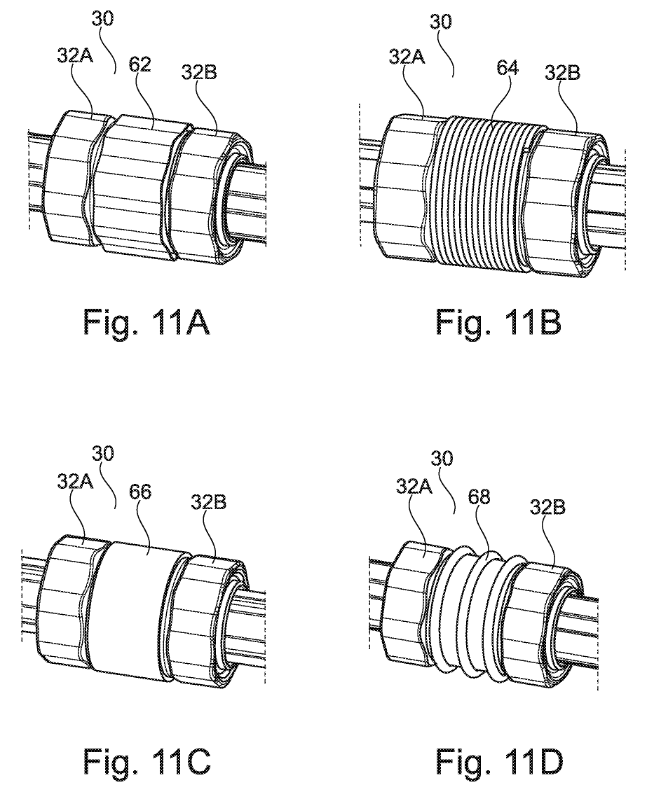

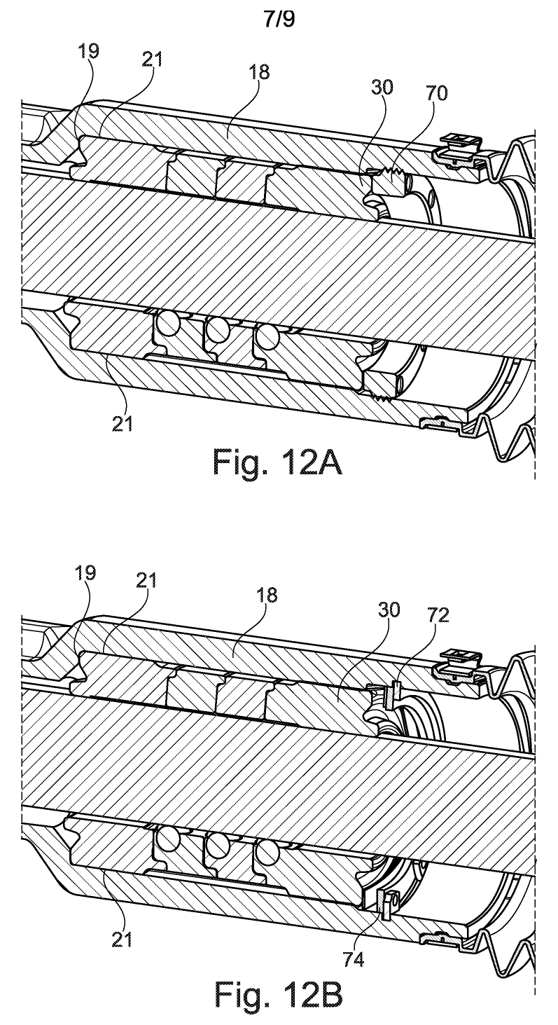

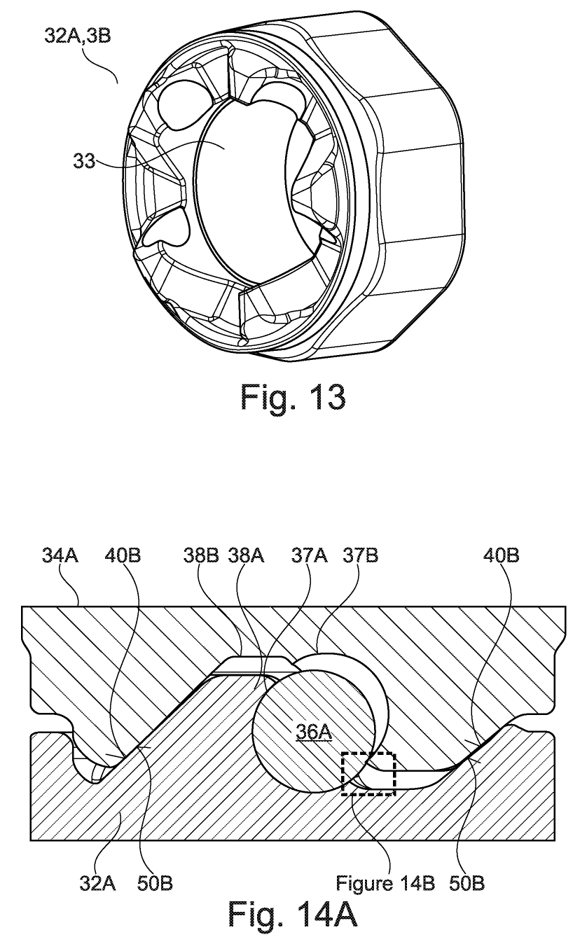

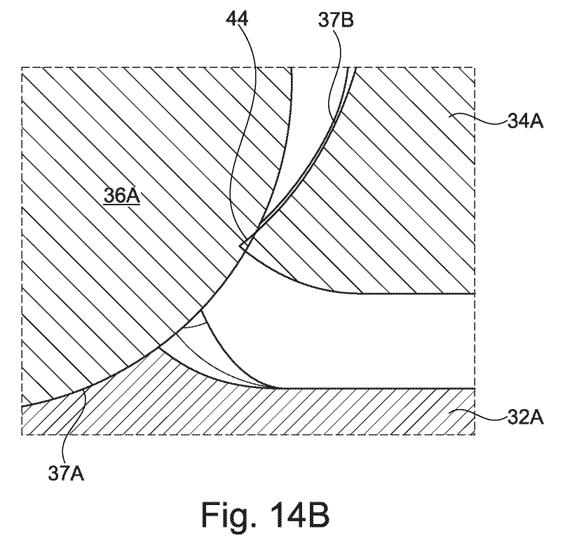

FIG. 1 is a perspective view of an example embodiment of a steering system actuator 100 for a steer by wire vehicle together with a threaded spindle 16 and an anti-rotation sleeve 30. FIG. 2 is a perspective view of the threaded spindle 16 and the anti-rotation sleeve 30. FIG. 3 is a perspective view of an end of the threaded spindle 16 together with the anti-rotation sleeve 30. FIG. 4 is a cross-sectional view of the anti-rotation sleeve 30 taken from FIG. 3 with the threaded spindle 16 removed for clarity purposes. FIG. 5 is an exploded perspective view of the anti-rotation sleeve 30. FIG. 6 is a perspective view of an end segment 32A, 32B of the anti-rotation sleeve 30. FIG. 7 is a perspective view of a modular segment 34A, 34B of the anti-rotation sleeve 30. FIGS. 8A, 8B, and 8C are perspective views of an assembly process of a portion of the anti-rotation sleeve 30. FIG. 9 is a cross-sectional view taken from FIG. 3. FIG. 10 is a partial cross-sectional view taken from FIG. 1. FIGS. 11A, 11B, 11C and 11D are perspective views of four different example embodiments of radial pre-load devices for the anti-rotation sleeve 30. FIGS. 12A and 12B are cross-sectional views taken from FIG. 1. FIG. 13 is a perspective view of the end segment 32A, 32B of the anti-rotation sleeve 30 together with a bushing 33. FIG. 14A is a front view of an assembly snap-fit of the modular segment 34A to the end segment 32A. FIG. 14B is a detailed view taken from FIG. 14A. The following description should be read in light of FIGS. 1 through 14B.

Turning to FIGS. 1 through 3, the steering system actuator 100 includes an electric motor 10 that rotatably drives a threaded nut 14 via a transmission 12. The transmission 12 can be a belt drive, geartrain, or any suitable transmission type. The threaded nut 14 threadably engages threads 22 of the threaded spindle 16 to convert rotary motion in either a first rotary direction R1 or a second rotary direction R2 to linear movement of the threaded spindle 16 in either a first axial direction AD1 or a second axial direction AD2 relative to an axis AX1. The threaded nut 14 can be supported by a rolling element bearing 15. The transmission 12 and threaded spindle 16 are disposed within a housing 18. The threaded spindle 16 has a first end 20A operatively connected to a first tie rod 60A and a second end 20B operatively connected to a second tie rod 60B. Each tie rod end is coupled to a corresponding wheel assembly; thus, linear movement of the threaded spindle 16 provides steering of the wheels of a vehicle.

In an example embodiment, the threaded nut 14 is a ball nut, known within steering systems, that utilizes a plurality of balls arranged between the threads of the ball nut and the threads 22 of the threaded spindle 16. Other suitable screw systems could also be applied to the steering system actuator 100. Further, any other suitable drive arrangement that converts rotary motion to linear motion could be applied to the steering system actuator 100.

The threads 22 of the threaded spindle 16 extend from the first end 20A to a medial position. A plurality of circumferentially spaced axially extending grooves 24 extend from a second end 20B of the threaded spindle 16 to a medial position.

Turning to FIGS. 12A and 12B, the anti-rotation sleeve 30 is fixed to the housing 18 so that it can not move axially or circumferentially. The axial fixation is accomplished via: i) a radial step 19 that the anti-rotation sleeve 30 abuts with upon insertion within the housing 18, and ii) one of either a threaded retention nut 70 (FIG. 12A) or a snap ring 72 (FIG. 12B). A wave spring 74 could also be inserted axially between either the snap ring 72 and the anti-rotation sleeve 30 or the threaded retention nut 70 and the anti-rotation sleeve 30 for biasing purposes to ensure a lash-free design over the lifetime of the steering system actuator 100. Any suitable axial retention device or combination thereof not shown in the figures could also be utilized.

In an example embodiment, circumferential or torsional fixation of the anti-rotation sleeve 30 is provided via flats 42 arranged circumferentially around first and second end segments 32A, 32B of the anti-rotation sleeve 30. The flats 42 correspond to flats 21 arranged in the housing 18. The fitment between the flats 42 of the anti-rotation sleeve 30 and the flats 21 of the housing can be a slip fit, an interference fit, or any other suitable fit. In a further aspect, a wide array of non-round profiles could also be applied to the anti-rotation sleeve 30 and/or interfacing portion of the housing 18 to achieve torsional fixation. Other suitable features not described herein or shown in the figures could also be applied to the anti-rotation sleeve 30 and/or the interfacing portion of the housing 18.

The second end 20B of the threaded spindle 16 extends through the anti-rotation sleeve 30 via a through-bore 26. The act of the anti-rotation sleeve 30 preventing rotation of the threaded spindle 16 during its linear displacement in either the first axial direction AD1 or the second axial direction AD2 is accomplished via balls 36 that are rollably captured within pockets 37 of the anti-rotation sleeve 30. The captured balls 36 engage the plurality of circumferentially spaced axially extending grooves 24 of the threaded spindle 16. During linear movement or displacement of the threaded spindle 16, the balls 36, which can spin or rotate within the pockets 37, rollably engage the grooves 24. Thus, the anti-rotation sleeve 30 prevents relative rotational movement between the threaded spindle 16 and the housing 18 while allowing axial movement between them. The structure of the anti-rotation sleeve 30 will now be described.

The anti-rotation sleeve 30 can be constructed from multiple lockable segments, including a first end segment 32A, a first modular segment 34A, a second modular segment 34B, and a second end segment 32B. The anti-rotation sleeve 30 includes a first plurality of balls 36A, a second plurality of balls 36B, and a third plurality of balls 36C. The first plurality of balls 36A can form a first row defined by a first ball circle C1 that extends through a center of each one of the first plurality of balls 36A; the second plurality of balls 36B can form a second row defined by a second ball circle C2 that extends through a center of each one of the second plurality of balls 36B; and the third plurality of balls 36C can form a third row defined by a third ball circle C3 that extends through a center of each one of the third plurality of balls 36C. Each one of the balls of the first plurality of balls 36A is isolated and separated from the other balls arranged on the first ball circle C1. Further, each of the three ball circles C1, C2, C3 are isolated and separated from each other. The anti-rotation sleeve 30 is modular or scalable to address varying magnitudes of torsional loads that exist amongst steering systems. Thus, the anti-rotation sleeve 30 is scalable from a single plurality of balls up to any desirable number of a plurality of balls.

Each of the three plurality of balls 36A, 36B, 36C are arranged within the anti-rotation sleeve 30 such that they protrude radially inwardly from the through-bore 26 to engage the axially extending grooves 24 on the threaded spindle 16. Stated otherwise, a ball circle C4 that connects an inner-most extent of each ball within one of the pluralities of balls defines a diameter ID1 that is smaller than a diameter SD1 of the through-bore 26 (see FIG. 9). Axially adjacent balls 36 within each of the three plurality of balls 36A, 36B, 36C can be aligned such that a line L1 that is parallel to the axis AX1 passes through a center of each of the adjacent balls (see FIG. 4). Axially aligned balls may rollably engage a same one of the axially extending grooves 24.

The sleeve segments 32A, 32B, 34A, 34B of the anti-rotation sleeve 30, and the geometry thereof, will now be described. The ball pockets 37 of the anti-rotation sleeve 30 are spherical and arranged in such a way that contact pressure between one of the balls 36 and the corresponding pocket 37 is minimized. Turning to FIG. 9, the factors that influence this contact pressure are bearing contact angle Ɵ (theta), number of balls, diameter of the balls, and contact area of the ball pocket 37. The number and size of the balls 36 is mainly packaging space driven. Increasing the bearing contact angle Ɵ, in turn, increases a moment arm length (d) which, in turn, reduces a force (F) for any given torsional load. Increasing the bearing contact angle Ɵ becomes more difficult as the angle increases, due to it also being inversely related to an available contact area of the pocket 37. In an example embodiment, to maximize both bearing contact angle Ɵ and contact area of the pocket 37, a radial clearance between the threaded spindle 16 and anti-rotation sleeve 30 is minimized in order to facilitate a geometry of the pocket 37 that extends past an equator of the balls 36.

Turning to FIGS. 6 and 7, by splitting a geometry of the pocket 37 into two components, (for example, a first ball pocket portion 37A and a second ball pocket portion 37B), a split line SL1 of the ball pocket 37 is created. In the example embodiment shown in the figures, the split line SL1 is arranged at an angle A1 so that it is located away from a highly loaded contact area of the ball pocket 37 in order to minimize edge loading and potential misalignment within the ball pocket 37 that could potentially reduce contact area between the pocket 37 and the ball 36. The split line SL1 is proximate to the equator of the ball 36.

As shown in FIG. 6, the first end segment 32A of the anti-rotation sleeve 30 is formed with circumferentially spaced tabs 38A. The tabs 38A could also be described as axially extending protrusions. Each of the tabs 38A includes or is formed by a first landing 40A and a second landing 40B. The first landing 40A is formed at a first angle A1, and the second landing 40B is formed at a second angle A2 such that the two landings 40A, 40B form an axially extending summit 39A or peak. It could also be stated that the first and second landings 40A, 40B are inclined or angled relative to the axis AX1. The two angles A1, A2 can be optimized for strength and/or assembly ease. First ball pocket portions 37A are formed within each of the first landings 40A. The first ball pocket portions 37A are spherical and could be described as truncated hemispheres or spherical segments. The circumferentially spaced tabs 38A form slots 41A (or valleys) between the tabs 38A; therefore, the slots 41A are also circumferentially spaced. It could also be stated that the first and second landings 40A, 40B, which define the tabs 38A, also define at least a portion of the slots 41A.

Now turning to FIG. 7, the first modular segment 34A of the anti-rotation sleeve 30 is formed with circumferentially spaced tabs 38B that form slots 41B between the tabs 38B. The tabs 38B could also be described as axially extending protrusions that protrude beyond a first end 56A of a cylindrical portion 57 of the first modular segment 34A. Each of the tabs 38B is formed by a first landing 50A and a second landing 50B. The first landing 50A is formed at a first angle B1 and the second landing 50B is formed at a second angle B2 such that the two landings 50A, 50B form an axially extending summit 39B or peak. It could also be stated that the first and second landings 50A, 50B are inclined or angled relative to the axis AX1. In an example embodiment, the first and second angles B1, B2 are the same as the first and second angles A1, A2 described earlier. Second ball pocket portions 37B are formed within each of the first landings 50A. The second ball pocket portions 37B are spherical and could be described as truncated hemispheres. The circumferentially spaced tabs 38B form slots 41B between the tabs 38B; therefore, the slots 41B are also circumferentially spaced. It could also be stated that the first and second landings 50A, 50B, which define the tabs 38B, also define at least a portion of the slots 41B. The previously described structure is also repeated on an underside of the first modular segment 34A, as viewed in FIG. 7. Circumferentially spaced tabs 46 protrude beyond a second end 56B of the cylindrical portion 57 and form slots identical or similar to the previously described slots 41B. Therefore, it could be stated that each side of first modular segment 34A includes duplicate tabs, slots, landings, and pockets.

Turning to FIGS. 8A through 8C, an example embodiment of a manufacturing process to partially assemble the anti-rotation sleeve 30 will now be described. The manufacturing process starts by providing the first end segment 32A shown in FIG. 8A. The process continues by adding the first plurality of balls 36A to the first ball pocket portions 37A, which forms a first subassembly 80 shown in FIG. 8B.

Next, the first modular segment 34A is assembled to the first subassembly 80 in the first axial direction AD1 until the second landings 50B of the first modular segment 34A slidably engage the second landings 40B of the first end segment 32A. When such engagement occurs, continued travel in the first axial direction AD1 yields a combination of axial movement in the first axial direction AD1 and rotational movement in the first rotational direction R1, until a snap-fit of an edge 44 of the second ball pocket portions 37B occurs around the first plurality of balls 36A, forming a snap-fit subassembly 82. The completed snap-fit is shown in FIG. 8C. FIGS. 14A and 14B show the beginnings of the snap-fit in which interference between the edges 44 of the second ball pocket portions 37B and the balls 36A starts to occur; such an interference then induces elastic deflection of the second ball pocket portions 37B and/or the edges 44 until the edges 44 snap around the first plurality of balls 36A. This snap-fit subassembly 82 not only couples the two segments together both axially and circumferentially, but also captures the first plurality of balls 36A. The term “captures” in this instance signifies that the ball pockets 37 formed by the first and second ball pocket portions 37A, 37B of the respective first end segment 32A and the first modular segment 34A encompass or envelope greater than 50% of a surface area of each of the first plurality of balls 36A. Stated otherwise, the resultant ball pockets 37 (or the edges thereof) extend beyond the equator of each of the first plurality of balls 36A, such that a diameter D2 of an opening of the ball pockets 37 (see FIGS. 4, 8C) formed on a radial inner surface 46 of the through-bore 26 of the anti-rotation sleeve 30 is less than a diameter D1 of each of the first plurality of balls 36A. When the first modular segment 34A is assembled with the first end segment 32A: i) the circumferentially spaced tabs 38B nest within or are received by the circumferentially spaced slots 41A, and the circumferentially spaced tabs 38A nest within the circumferentially spaced slots 41B. Alternatively stated, after assembly of the two segments 34A, 32A, one of the circumferentially spaced tabs 38B-1 is disposed in a locked manner between a first one 38A-1 and a directly adjacent second one 38A-2 of the circumferentially spaced tabs 38A (see FIG. 4). Therefore, the first modular segment 34A and the first end segment 32A form a circumferentially spaced tab and slot coupling C1 that, via the circumferentially alternating tabs and slots, forms the ball pockets 37.

The previously described snap-fit results in the first landing 40A of the circumferentially spaced tabs 38A of the first end segment 32A engaging the first landing 50A of the circumferentially spaced tabs 38B of the first modular segment 34A in a locked manner. This abutment between the surfaces of these landings defines the split line SL1 of the ball pockets 37, as represented by the angle A1. It could also be stated that the circumferentially spaced tabs 38A of the first end segment 32A complementarily engage the circumferentially spaced tabs 38B of the first modular segment 34A.

In order to complete the assembly shown in the figures, the second plurality of balls 36B is added to the first modular segment 34A, and then via a combined movement in the first axial direction AD1 and the first rotational direction R1, the second modular segment 34B, which is identical to the first modular segment 34B in this example embodiment, is snapped around the second plurality of balls 36B. Following this, the third plurality of balls 36C is added to the second modular segment 34B, and then, via a combined movement in the first axial direction AD1 and the first rotational direction R1, the second end segment 32B is snapped around the third plurality of balls 36C to complete the assembly of the anti-rotational sleeve 30.

An alternative assembly of the first modular segment 34A, the first plurality of balls 36A, and the first end segment 32A includes inserting the first modular segment 34A into the first end segment 32A without the first plurality of balls 36A installed. After this subassembly, each one of the first plurality of balls 36A can be forcibly inserted into the ball pockets 37 through, as described earlier, an opening of the formed ball pockets 37 that has a smaller diameter D2 than a diameter D1 of each of the first plurality of balls 36A. Snapping in the balls couples or locks the first modular segment 34A to the first end segment 32A. This process can be repeated for the remaining second modular segment 34B and the second end segment 32B. Alternatively, more than two sleeve segments can be “stacked” and then the balls can be snapped into the formed ball pockets to couple the additional segments together.

The anti-rotation sleeve 30 is scalable or modular in nature to accommodate a variation of torsional force magnitudes that occur in different steering systems. In an example embodiment with low torsional forces, only the first plurality of balls 36A may be necessary; therefore, only the first and second end segments 32A, 32B are required. In a further example embodiment with higher torsional forces, only the first and second pluralities of balls 36A, 36B may be necessary; therefore only the first modular segment 34A and the first and second end segments 32A, 32B are required. In yet another example embodiment, the torsional forces may be extremely high, therefore, additional pluralities of balls can be added along with corresponding additional modular segments. The modular segments can be identical to each other, as shown in the figures, or different from each other.

The figures show that each of the pluralities of balls includes five balls; however, the number and size of the balls can vary to accommodate varying packaging and torsional force requirements.

In an example embodiment, the sleeve segments, or at least a portion thereof, can be constructed from a polymer; however, any suitable material could be used. Furthermore, the sleeve segments could also utilize an insert molding process with metal components or an overmolding process. A wide array of polymers could be utilized for the sleeve segments, in addition to any suitable additive (for example, molybdenum) that could offer improved wear characteristics. Given the inherent flexibility of the polymeric sleeve segments 32A, 32B, 34A, 34B, the sleeve segments may be dimensioned in such a way that they provide an amount of preload on the balls 36 against the plurality of grooves 24 on the threaded spindle 16. Such a preload can reduce or eliminate lash or clearance between balls 36 and their interfacing components (ball pockets 37 of segments, grooves 24 of threaded spindle), which, can reduce NVH, wear and other detrimental effects of lash in the steering system. Additionally, this preloaded and flexible design will more evenly distribute load across all of the balls 36 within the system, resulting in more even wear and better frictional performance.

The described sleeve segments 32A, 32B, 34A, 34B could be described as separate sleeve segments that are assembled via a snap-fit or any other suitable method to form a modular anti-rotation sleeve 30. In an example embodiment, each of the sleeve segments are constructed as separate pieces that, once assembled, can also be disassembled. Thus, each of the sleeve segments is separable from an adjacent sleeve segment.

Turning to FIG. 10, an example embodiment of an optional overload protection feature is shown that is achieved via a radial clearance RC1 between a medial portion of the anti-rotation sleeve 30 and the flat 21 of the housing 18. This radial clearance RC1 accommodates bending of the threaded spindle 16 so as to not overload the polymeric anti-rotation sleeve 30. Further in FIG. 10, outer edges 28 of the first and second end segments 32A, 32B are flanged so that these outer edges deflect more easily than other portions of the anti-rotation sleeve 30. These non-critical edge bending locations prevent excessive bending of other more critical features or areas of the anti-rotation sleeve 30.

In some example embodiments, due to excessive radial loading, extreme temperature ranges, lower cost material selections, long lifetime/duty cycle requirements, and restrictive packaging spaces, the material of the sleeve segments may not be able to adequately preload the balls 36. For these example embodiments, an additional radially inwardly acting spring force that acts on the ball pockets can be added to the sleeve segments in various ways. FIGS. 11A through 11D show four example embodiments of providing such an additional (or supplementary) radial spring force in addition to the inherent preload provided via the material selection.

As shown in FIG. 11A, a radial wave spring 62 is arranged around a medial portion of the anti-rotation sleeve 30.

As shown in FIG. 11B, a wrap spring 64 is arranged around the medial portion of the anti-rotation sleeve 30.

As shown in FIG. 11C, a press-fit sleeve 66 is arranged around the medial portion of the anti-rotation sleeve 30.

As shown in FIG. 11D, elastic O-rings 68 are arranged around the medial portion of the anti-rotation sleeve 30.

In the above example embodiments, each of the supplemental spring members circumscribe an outer circumference of the second a third modular segments 34A, 34B, which have a smaller outer diameter than that of the first and second end segments 32A, 32B. These spring members may or may not contact an inner surface of the housing 18 that surrounds the anti-rotation sleeve 30.

Turning to FIG. 6, each of the first and second end segments 32A, 32B include a longitudinally extending bore 54 (defining a portion of the through-bore 26) that slidably interfaces with the threaded spindle 16. Turning to FIG. 13, an optional integrated overload metal bushing 33 can be applied to the bore 54 if resistance to higher radial loads imparted by the threaded spindle 16 is required. An insert molding manufacturing process or any other suitable attachment method could be utilized to fix metal bushing 33 to the bore 54. The radial loads are translated radially from the bore 54 and/or metal bushing 33 to the flats 42 on the outer circumferences of the end segments, which are then transferred directly to the corresponding flats 21 of the housing 18.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle steering system, comprising:
an actuator driving a threaded nut;
a threaded spindle disposed in a housing, the threaded spindle configured to move linearly along a first axis within the housing via rotation of the threaded nut;
a sleeve fixed to the housing, the sleeve configured to prevent rotation of the threaded spindle about the first axis, the sleeve comprising:
a through-bore through which the threaded spindle extends;
a first plurality of balls configured to rollably engage a plurality of axial grooves disposed on the threaded spindle;
a first plurality of spherical ball pockets, each of the first plurality of spherical ball pockets rollably receiving one of the first plurality of balls; and
at least one of the first plurality of spherical ball pockets formed by a first pair of spherical ball pocket portions.

2. The vehicle steering system of claim 1, wherein each one of the first plurality of spherical ball pockets is isolated from each other.

3. The vehicle steering system of claim 1, wherein the first pair of spherical pocket portions includes:
a first spherical portion formed within a first angled landing; and,
a second spherical portion formed within a second angled landing that abuts with the first angled landing.

4. The vehicle steering system of claim 1, wherein the sleeve is assembled from a plurality of separate sleeve segments, and:
a first one of the plurality of separate sleeve segments includes a first one of the first pair of spherical ball pocket portions; and
a second one of the plurality of separate sleeve segments includes a second one of the first pair of spherical ball pocket portions.

5. The vehicle steering system of claim 4, wherein the first one and the second one of the plurality of separate sleeve segments are constructed from a polymer.

6. The vehicle steering system of claim 4, further comprising:
a second plurality of balls configured to rollably engage the plurality of axial grooves;
a second plurality of spherical ball pockets, each of the second plurality of spherical ball pockets rollably receiving one of the second plurality of balls, and at least one of the second plurality of spherical ball pockets formed by a second pair of ball pocket portions;
a third one of the plurality of separate sleeve segments including a first one of the second pair of spherical ball pocket portions; and
a fourth one of the plurality of separate sleeve segments including a second one of the second pair of spherical ball pocket portions.

7. The vehicle steering system of claim 6, wherein each one of the second plurality of balls is separated from each other.

8. The vehicle steering system of claim 1, further comprising:
a second plurality of balls configured to rollably engage the plurality of axial grooves; and
a second plurality of spherical ball pockets, each of the second plurality of spherical ball pockets rollably receiving one of the second plurality of balls; and
at least one of the second plurality of spherical ball pockets formed by a second pair of ball pocket portions; and
wherein one of the first plurality of balls is axially aligned with one of the second plurality of balls so that both balls rollably engage a same one of the plurality of axial grooves disposed on the threaded spindle.

9. The vehicle steering system of claim 6, wherein the first plurality of balls form a first ball circle and the second plurality of balls form a second ball circle axially displaced from the first ball circle.

10. A vehicle steering system, comprising:
an actuator driving a threaded nut;
a threaded spindle disposed in a housing, the threaded spindle configured to move linearly along a first axis within the housing via rotation of the threaded nut;
a sleeve fixed to the housing, the sleeve configured to prevent rotation of the threaded spindle about the first axis, the sleeve comprising:
a through-bore through which the threaded spindle extends;
a plurality of snap-fit sleeve segments forming a first plurality of ball pockets; and
a first plurality of balls configured to rollably engage a plurality of axial grooves disposed on the threaded spindle, and each one of the first plurality of balls disposed within a corresponding one of the first plurality of ball pockets.

11. The vehicle steering system of claim 10, wherein the first plurality of ball pockets are formed via angled sides of the plurality of snap-fit sleeve segments.

12. The vehicle steering system of claim 10, wherein the plurality of snap-fit sleeve segments form a circumferentially alternating tab and slot coupling.

13. The vehicle steering system of claim 12, wherein the circumferentially alternating tab and slot coupling comprises the first plurality of ball pockets.

14. The vehicle steering system of claim 10, wherein the first plurality of ball pockets are formed via: i) a first ball pocket portion formed within a first angled landing of one of the plurality of snap-fit sleeve segments, and ii) a second ball pocket portion formed within a second angled landing of another one of the plurality of snap-fit sleeve segments.

15. The vehicle steering system of claim 14, wherein the first angled landing engages the second angled landing to define an angled split line of the first ball pocket.

16. A vehicle steering system, comprising:
an actuator driving a threaded nut;
a threaded spindle disposed in a housing, the threaded spindle configured to move linearly along a first axis within the housing via rotation of the threaded nut;
a sleeve fixed to the housing, the sleeve configured to prevent rotation of the threaded spindle about the first axis, the sleeve comprising:
a plurality of separate sleeve segments forming a plurality of ball pockets, the plurality of separate sleeve segments having:
a first separate sleeve segment having a first plurality of axial protrusions; and
a second separate sleeve segment having a second plurality of axial protrusions that complementarily engage the first plurality of axial protrusions so as to form the plurality of ball pockets; and
a plurality of balls rollably disposed within the plurality of ball pockets.

17. The vehicle steering system of claim 16, wherein:
at least one of the first plurality of axial protrusions comprises a first portion of one of the plurality of ball pockets; and
at least one of the second plurality of axial protrusions comprises a second portion of the one of the plurality of ball pockets.

18. The vehicle steering system of claim 17, wherein the first portion and the second portion are shaped as spherical segments.

19. The vehicle steering system of claim 17, wherein the first portion is formed on a first angled side of the at least one of the first plurality of axial protrusions, and the second portion is formed on a second angled side of the at least one of the second plurality of axial protrusions, and the second angled side complementarily engages the first angled side.

20. The vehicle steering system of claim 16, wherein a first one of the first plurality of axial protrusions is lockingly disposed circumferentially between a first one and a directly adjacent second one of the second plurality of axial protrusions.
